(19) United States
(12) Patent Application Publication
(10) Pub. No.: US 2026/0296802 A1
(43) Pub. Date: Oct. 1, 2026

(54) OFFSET FLYWHEEL DEVICE

(71) Applicant: Larry Sturgill, Sheffield Lake, OH (US)

(72) Inventor: Larry Sturgill, Sheffield Lake, OH (US)

(21) Appl. No.: 19/308,665

(22) Filed: Aug. 25, 2025

Related U.S. Application Data
(60) Provisional application No. 63/778,539, filed on Mar. 27, 2025.

(51) Int. Cl. B65G 47/84; B65G 29/02

(52) U.S. Cl. CPC B65G 47/846; B65G 29/02

(57) ABSTRACT

An offset flywheel device is provided having moving platforms which may be used to move and position objects placed thereon. The device may include a first axle that may be coupled to a first axle rotational coupling. A first plurality of elongated spokes may be coupled to the first axle. A second axle may be coupled to a second axle rotational coupling, and a second plurality of elongated spokes may be coupled to the second axle. A plurality of platforms may be coupled to the first and second plurality of elongated spokes. Each platform may be movably coupled to one elongated spoke of the first plurality of elongated spokes and to one elongated spoke of the second plurality of elongated spokes, and the plurality of platforms may rotationally couple the first plurality of elongated spokes to the second plurality of elongated spokes.

### CROSS REFERENCE TO RELATED APPLICATIONS

This application claims priority to and the benefit of the filing date of U.S. Provisional Application No. 63/778,539, filed on Mar. 27, 2025 entitled “Offset Flywheel Device”, which is hereby incorporated by reference in its entirety.

### FIELD OF THE INVENTION

This patent specification relates to the field of load moving and positioning devices. More specifically, this patent specification relates to a device having moving platforms which may be used to move and position objects placed thereon.

### BACKGROUND

The movement of equipment and objects is an ever-present need. This need is especially felt in high precision manufacturing and industrial environments which typically utilize robot arms and/or robotic picking stations. For example, in these environments, the robot arms and/or robotic picking stations need a steady supply of parts and objects that need to be presented in a consistent orientation so that the robot arms and/or robotic picking stations can access and manipulate the parts and objects in a speedy and efficient manner. The presentation of parts and objects in a consistent orientation is beneficial to the efficiency and performance of human workers as well.

Therefore, a need exists for novel load moving and positioning devices. A further need exists for novel devices having moving platforms which may be used to move and position objects placed thereon. There is also a need for novel devices which are able to provide a steady supply of parts and objects so that the parts and objects are presented in a consistent orientation.

### BRIEF SUMMARY OF THE INVENTION

An offset flywheel device is provided having moving platforms which may be used to move and position objects placed thereon. Preferably, the platforms may operate as carriers for objects, and the platforms may move through space while remaining horizontal at all times. For example, the platforms are capable of holding open containers that are being raised or lowered with fluid or small parts that may roll, without spillage and the device can be used in an industrial environment to provide objects on the platforms to robot arms, robotic picking stations, human workers, etc. so that the objects are presented in a consistent orientation.

In some embodiments, the device may include a first axle that may be coupled to a first axle rotational coupling, and the first axle may have a first axle hub. A first plurality of elongated spokes may be coupled to the first axle hub, and each elongated spoke of the first plurality of elongated spokes may radiate from the first axle hub. A second axle may be coupled to a second axle rotational coupling, and the second axle may have a second axle hub. A second plurality of elongated spokes may be coupled to the second axle hub, and each elongated spoke of the second plurality of elongated spokes may radiate from the second axle hub. A plurality of platforms may be coupled to the first plurality of elongated spokes and to the second plurality of elongated spokes. Each platform of the plurality of platforms may be movably coupled to one elongated spoke of the first plurality of elongated spokes and to one elongated spoke of the second plurality of elongated spokes, and the plurality of platforms may rotationally couple the first plurality of elongated spokes to the second plurality of elongated spokes so that rotation of the first plurality of elongated spokes causes equal rotation of the second plurality of elongated spokes.

In further embodiments, the device may include a first axle that may be coupled to a first axle rotational coupling, and the first axle may have a first axle hub. A first plurality of elongated spokes may be coupled to the first axle hub, and each elongated spoke of the first plurality of elongated spokes may radiate from the first axle hub. A second axle may be coupled to a second axle rotational coupling, and the second axle may have a second axle hub. The first axle and the second axle may be coupled together via flexible coupling. A second plurality of elongated spokes may be coupled to the second axle hub, and each elongated spoke of the second plurality of elongated spokes may radiate from the second axle hub. A plurality of platforms may be coupled to the first plurality of elongated spokes and to the second plurality of elongated spokes. Each platform of the plurality of platforms may be movably coupled to one elongated spoke of the first plurality of elongated spokes and to one elongated spoke of the second plurality of elongated spokes, and the plurality of platforms may rotationally couple the first plurality of elongated spokes to the second plurality of elongated spokes so that rotation of the first plurality of elongated spokes causes equal rotation of the second plurality of elongated spokes. Preferably, each platform of the plurality of platforms may have a connection distance, and each connection distance may be substantially equal. Preferably, each platform of the plurality of platforms may have an orientation, and the orientation of each platform of the plurality of platforms remains substantially constant as the first plurality of elongated spokes and the second plurality of elongated spokes are rotated around a horizontal axis extending parallel to and between the first axis of rotation and the second axis of rotation.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a first side perspective view of an example of an offset flywheel device according to various embodiments described herein.

FIG. 2 illustrates a second side perspective view of an example of an offset flywheel device according to various embodiments described herein.

FIG. 3 shows a top perspective view of an example of an offset flywheel device according to various embodiments described herein.

FIG. 4 depicts a further side perspective view of an example of an offset flywheel device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

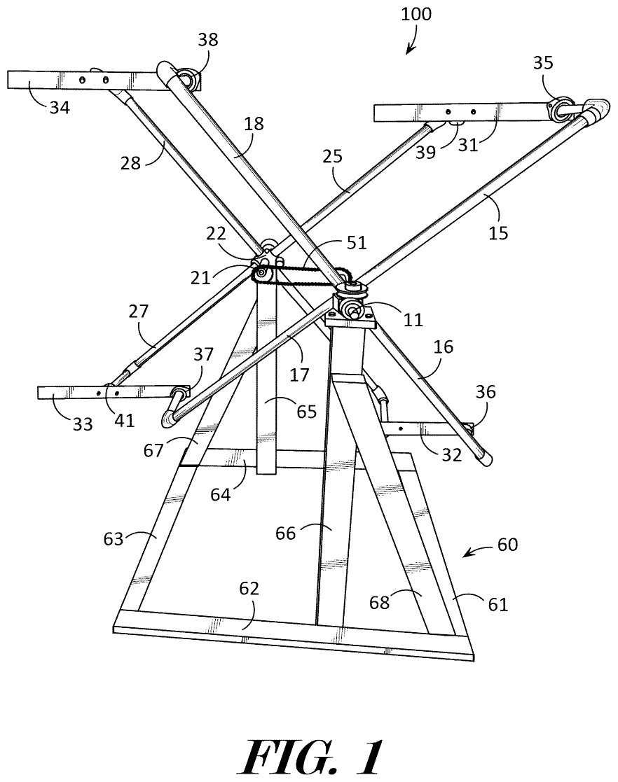

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

As used in this application, the term “substantially parallel” refers to a range of values within plus or minus 2.0 degrees of absolute parallel (lines, planes, surfaces, or objects side by side and having the same distance continuously between them e.g., parallel lines never meet). More preferably, the term “substantially parallel” may refer to a range of values within plus or minus 0.5 degrees of absolute parallel.

A new offset flywheel device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

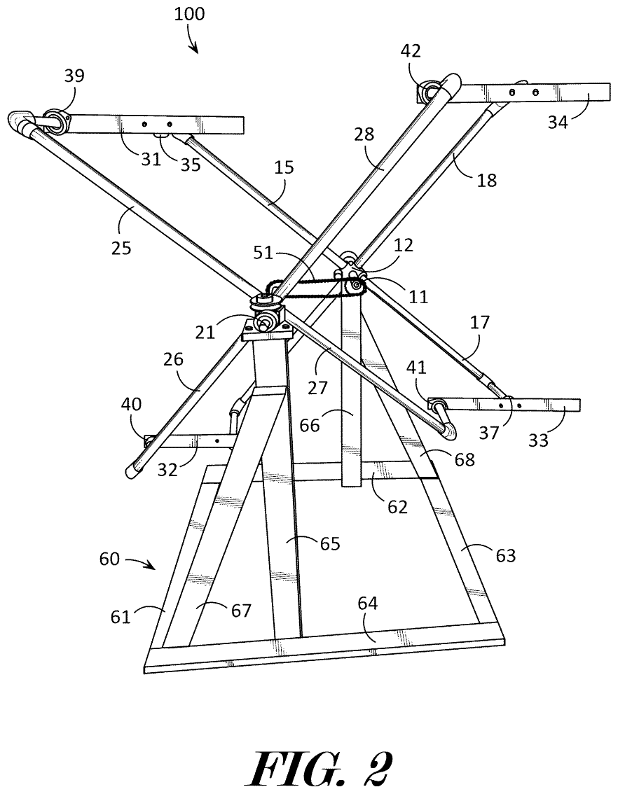

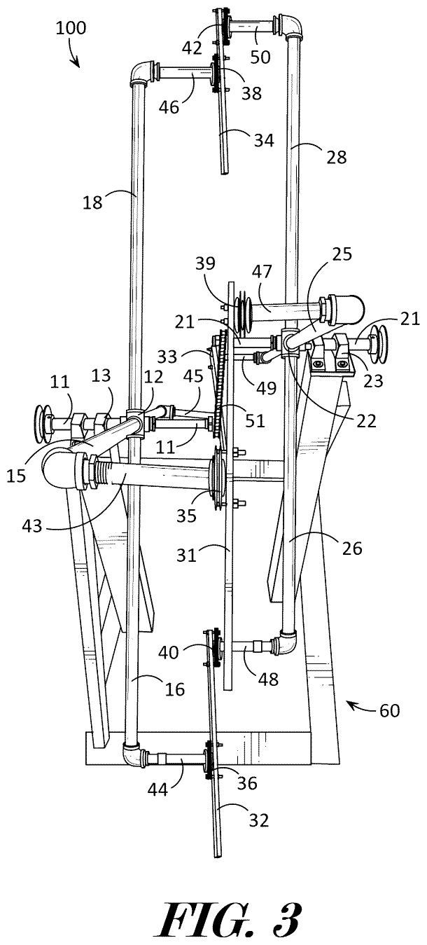

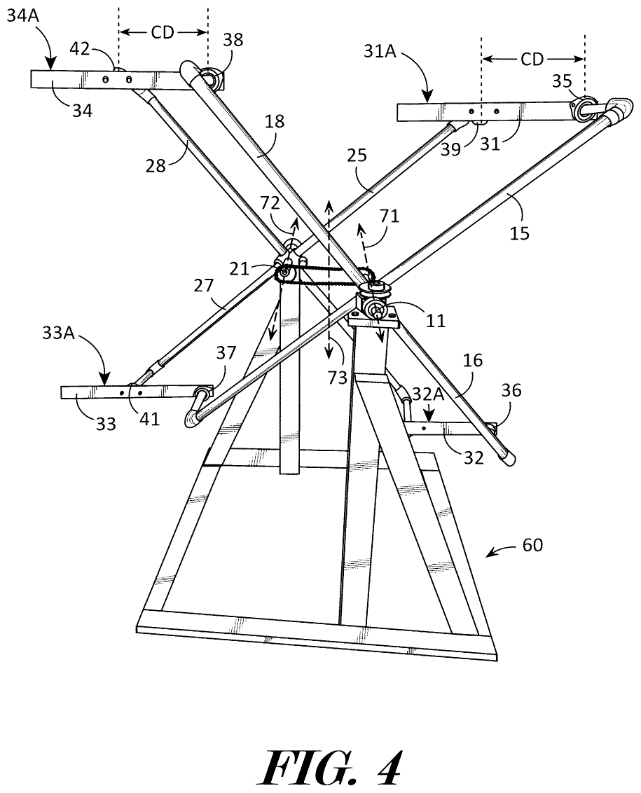

The present invention will now be described by example and through referencing the appended figures representing preferred and alternative embodiments. FIG. 1-4 illustrate an example of an offset flywheel device (“the device”) 100 according to various embodiments. In some embodiments, the device 100 may comprise a first axle 11 coupled to a first axle rotational coupling 13, and the first axle 11 may have a first axle hub 12. A first plurality of elongated spokes 15, 16, 17, 18, may be coupled to the first axle hub 12, and each elongated spoke 15, 16, 17, 18, of the first plurality of elongated spokes 15, 16, 17, 18, may radiate from the first axle hub 12. A second axle 21 may be coupled to a second axle rotational coupling 23, and the second axle 21 may have a second axle hub 22. A second plurality of elongated spokes 25, 26, 27, 28, may be coupled to the second axle hub 22, and each elongated spoke 25, 26, 27, 28, of the second plurality of elongated spokes 25, 26, 27, 28, may radiate from the second axle hub 22. A plurality of platforms 31, 32, 33, 34, may be coupled to the first plurality of elongated spokes 15, 16, 17, 18, and to the second plurality of elongated spokes 25, 26, 27, 28. Each platform 31, 32, 33, 34, of the plurality of platforms 31, 32, 33, 34, may be movably coupled to one elongated spoke 15, 16, 17, 18, of the first plurality of elongated spokes 15, 16, 17, 18, and to one elongated spoke 25, 26, 27, 28, of the second plurality of elongated spokes 25, 26, 27, 28, and the plurality of platforms 31, 32, 33, 34, may rotationally couple the first plurality of elongated spokes 15, 16, 17, 18, to the second plurality of elongated spokes 25, 26, 27, 28, so that rotation of the first plurality of elongated spokes 15, 16, 17, 18, causes equal rotation of the second plurality of elongated spokes 25, 26, 27, 28.

In preferred embodiments, the device 100 may comprise a first axle 11 that may be coupled to one or more first axle rotational couplings 13. Generally, a first axle 11 may comprise a central shaft that may connect the elongated spokes of the first plurality of elongated spokes 15, 16, 17, 18, to another object, such as a stand 60, a flexible coupling 51, a pulley, a gear, etc., via a first axle rotational coupling 13. A first axle rotational coupling 13 preferably may comprise a bearing that allows relative motion between two parts, with minimal friction, while also supporting loads. For example, a first axle rotational coupling 13 may comprise one or more ball bearings, roller bearings, plain bearings, etc. A first axle rotational coupling 13 allows the first axle 11 to rotate smoothly relative to the first axle rotational coupling 13 and to an object that the first axle rotational coupling 13 is coupled to. Preferably, a first axle 11 may be coupled to two first axle rotational couplings 13, and the first axle rotational couplings 13 may movably couple the first axle 11 to an object, such as a stand 60.

A first axle 11 may comprise a first axle hub 12 that may couple each elongated spoke 15, 16, 17, 18, of the first plurality of elongated spokes 15, 16, 17, 18, to the first axle 11 so that the elongated length of each elongated spoke 15, 16, 17, 18, radiates away from the first axle 11. A first axle hub 12 may be configured in any size and shape. The first axle 11 may comprise or provide a first axis of rotation 71. Generally, a first axis of rotation 71 may comprise the central line or pivot point upon which a circular motion of the first plurality of elongated spokes 15, 16, 17, 18, occurs.

The device 100 may comprise a first plurality of elongated spokes 15, 16, 17, 18, coupled to the first axle hub 12. Preferably, an elongated spoke 15, 16, 17, 18, may comprise a rod, bar, or other elongated structure that may preferably be made from or may comprise a rigid material, such as metal, plastic, wood, etc., and that connects the first axle hub 12 to a platform 31, 32, 33, 34, of the plurality of platforms 31, 32, 33, 34. An elongated spoke 15, 16, 17, 18, may be elongated (elongated in shape) so as to have a length that is significantly greater in dimension than the height and width dimensions. Generally, the elongated length of each elongated spoke 15, 16, 17, 18, may radiate from the first axle hub 12. A first plurality of elongated spokes 15, 16, 17, 18, may comprise two, three, four, five, six, seven, eight, or more elongated spokes 15, 16, 17, 18. In preferred embodiments, each elongated spoke 15, 16, 17, 18, of the first plurality of elongated spokes 15, 16, 17, 18, is substantially equal in length e.g., the elongated length of each elongated spoke may be substantially equal (plus or minus 5%, and more preferably plus or minus 1%).

In preferred embodiments, the device 100 may comprise a second axle 21 that may be coupled to one or more second axle rotational couplings 23. Generally, a second axle 21 may comprise a central shaft that may connect the elongated spokes of the second plurality of elongated spokes 25, 26, 27, 28, to another object, such as a stand 60, a flexible coupling 51, a pulley, a gear, etc., via a second axle rotational coupling 23. A second axle rotational coupling 23 preferably may comprise a bearing that allows relative motion between two parts, with minimal friction, while also supporting loads. For example, a second axle rotational coupling 23 may comprise one or more ball bearings, roller bearings, plain bearings, etc. A second axle rotational coupling 23 allows the second axle 21 to rotate smoothly relative to the second axle rotational coupling 23 and to an object that the second axle rotational coupling 23 is coupled to. Preferably, a second axle 21 may be coupled to two second axle rotational couplings 23, and the second axle rotational couplings 23 may movably couple the second axle 21 to an object, such as a stand 60.

A second axle 21 may comprise a second axle hub 22 that may couple each elongated spoke 25, 26, 27, 28, of the second plurality of elongated spokes 25, 26, 27, 28, to the second axle 21 so that the elongated length of each elongated spoke 25, 26, 27, 28, radiates away from the second axle 21. A second axle hub 22 may be configured in any size and shape. The second axle 21 may comprise or provide a second axis of rotation 72. Generally, a second axis of rotation 72 may comprise the central line or pivot point upon which a circular motion of the second plurality of elongated spokes 25, 26, 27, 28, occurs.

The device 100 may comprise a second plurality of elongated spokes 25, 26, 27, 28, coupled to the second axle hub 22. Preferably, an elongated spoke 25, 26, 27, 28, may comprise a rod, bar, or other elongated structure that may preferably be made from or may comprise a rigid material, such as metal, plastic, wood, etc., and that connects the second axle hub 22 to a platform 31, 32, 33, 34, of the plurality of platforms 31, 32, 33, 34. An elongated spoke 25, 26, 27, 28, may be elongated (elongated in shape) so as to have a length that is significantly greater in dimension than the height and width dimensions. Generally, the elongated length of each elongated spoke 25, 26, 27, 28, may radiate from the second axle hub 22. A second plurality of elongated spokes 25, 26, 27, 28, may comprise two, three, four, five, six, seven, eight, or more elongated spokes 25, 26, 27, 28. In preferred embodiments, each elongated spoke 25, 26, 27, 28, of the second plurality of elongated spokes 25, 26, 27, 28, is substantially equal in length e.g., the elongated length of each elongated spoke 25, 26, 27, 28, may be substantially equal (plus or minus 5%, and more preferably plus or minus 1%). In further embodiments, each elongated spoke 15, 16, 17, 18, of the first plurality of elongated spokes 15, 16, 17, 18, may be substantially equal in length (plus or minus 5%, and more preferably plus or minus 1%) to each elongated spoke 25, 26, 27, 28, of the second plurality of elongated spokes 25, 26, 27, 28. For example, the elongated length of each elongated spoke 15, 16, 17, 18, of the first plurality of elongated spokes 15, 16, 17, 18, may be substantially equal in length to the elongated length of each elongated spoke 25, 26, 27, 28, of the second plurality of elongated spokes 25, 26, 27, 28.

The device 100 may comprise a plurality of platforms 31, 32, 33, 34, that may be revolved or rotated around the first axle 11 and second axle 21. A plurality of platforms 31, 32, 33, 34, may comprise two, three, four, five, six, seven, eight, or more platforms 31, 32, 33, 34. Each platform 31, 32, 33, 34, of the plurality of platforms 31, 32, 33, 34, may be movably coupled to one elongated spoke 15, 16, 17, 18, of the first plurality of elongated spokes 15, 16, 17, 18, and also movably coupled to one elongated spoke 25, 26, 27, 28, of the second plurality of elongated spokes 25, 26, 27, 28. A platform 31, 32, 33, 34, may be configured in any size and shape. For example, a platform 31, 32, 33, 34, may comprise an elongated length with an elongated spoke 15, 16, 17, 18, of the first plurality of elongated spokes 15, 16, 17, 18, coupled at one point along the elongated length of the platform 31, 32, 33, 34, and with an elongated spoke 25, 26, 27, 28, of the second plurality of elongated spokes 25, 26, 27, 28, coupled at another point along the elongated length of the platform 31, 32, 33, 34.

It should be understood that the platforms 31, 32, 33, 34, and elongated spokes 15, 16, 17, 18, 25, 26, 27, 28, may be configured in any shape and size. Optionally, the device 100 may comprise one or more lateral extensions 43, 44, 45, 46, 47, 48, 49, 50, which may couple an elongated spoke 15, 16, 17, 18, 25, 26, 27, 28, to a platform 31, 32, 33, 34. For example, one or more elongated spokes 15, 16, 17, 18, 25, 26, 27, 28, may have an elongated length and they may have a lateral extension 43, 44, 45, 46, 47, 48, 49, 50, that extends away from the elongated length to a platform 31, 32, 33, 34, such as when a platform 31, 32, 33, 34, is narrower than the distance between the elongated lengths of the first plurality of elongated spokes 15, 16, 17, 18, and the second plurality of elongated spokes 25, 26, 27, 28. As another example, a platform 31, 32, 33, 34, may comprise one or more lateral extensions 43, 44, 45, 46, 47, 48, 49, 50, that may extend away from the main body of the platform 31, 32, 33, 34, towards the elongated length of elongated spokes 15, 16, 17, 18, of the first plurality of elongated spokes 15, 16, 17, 18, and/or one or more lateral extensions 43, 44, 45, 46, 47, 48, 49, 50, that may extend away from the main body of the platform 31, 32, 33, 34, towards the elongated length of elongated spokes 25, 26, 27, 28, of the second plurality of elongated spokes 25, 26, 27, 28, such as when such as when the main body of a platform 31, 32, 33, 34, is narrower than the distance between the elongated lengths of the first plurality of elongated spokes 15, 16, 17, 18, and the second plurality of elongated spokes 25, 26, 27, 28. A lateral extension 43, 44, 45, 46, 47, 48, 49, 50, may be configured in any size and shape, such as an elongated rod, bar, block, etc., and may be made of a preferably rigid material, such as metal, plastic, wood, etc.

Preferably, the device 100 may comprise a plurality of platform rotational couplings 35, 36, 37, 38, 39, 40, 41, 42, and each platform rotational coupling 35, 36, 37, 38, 39, 40, 41, 42, may movably couple an elongated spoke 15, 16, 17, 18, 25, 26, 27, 28, to a platform 31, 32, 33, 34. A platform rotational coupling 35, 36, 37, 38, 39, 40, 41, 42, may include a rivet, bearing, nut and bolt, knuckle joint, a turnbuckle, a pin joint, a pivot joint, a cotter joint, a bolted joint, a flexible material joint, a screw joint, a universal joint, a butt hinge, butterfly hinge, flush hinge, barrel hinge, concealed hinge, continuous hinge, T-hinge, strap hinge, double-acting hinge, Soss hinge, a flexible material hinge, a four-bar linkage, a scissor linkage, a collapsible pole linkage, or any other suitable mechanical or physical linkage which may be used to couple a first element or component to a second element or component while allowing the first element or component to move, pivot, or rotate relative to the second element or component.

Preferably, each platform 31, 32, 33, 34, of the plurality of platforms 31, 32, 33, 34, is movably coupled to one elongated spoke 15, 16, 17, 18, of the first plurality of elongated spokes 15, 16, 17, 18, via a first platform rotational coupling 35, 36, 37, 38, and is movably coupled to one elongated spoke 25, 26, 27, 28, of the second plurality of elongated spokes 25, 26, 27, 28, via a second platform rotational coupling 39, 40, 41, 42. In preferred embodiments, the plurality of platforms 31, 32, 33, 34, rotationally couples the first plurality of elongated spokes 15, 16, 17, 18, to the second plurality of elongated spokes 25, 26, 27, 28, so that rotation of the first plurality of elongated spokes 15, 16, 17, 18, causes equal rotation of the second plurality of elongated spokes 25, 26, 27, 28, and vice versa. In this manner, the plurality of platforms 31, 32, 33, 34, may rotationally engage the first axle 11 and the second axle 21 together so that rotation of one axle 11, 21, results in rotation of the other axle 11, 21.

In some embodiments, each platform 31, 32, 33, 34, of the plurality of platforms 31, 32, 33, 34, may comprise a connection distance (CD) that may describe the distance between a first platform rotational coupling 35, 36, 37, 38, (coupled to an elongated spoke 15, 16, 17, 18, of the first plurality of elongated spokes 15, 16, 17, 18,) and a second platform rotational coupling 39, 40, 41, 42, (coupled to an elongated spoke 25, 26, 27, 28, of the second plurality of elongated spokes 25, 26, 27, 28,) of a platform 31, 32, 33, 34. In preferred embodiments, each connection distance of the device 100 may be substantially equal (plus or minus 5%, and more preferably plus or minus 1%). In preferred embodiments, each connection distance of the device 100 may be substantially equal (plus or minus 5%, and more preferably plus or minus 1%) to the distance between the first axis of rotation 71 and the second axis of rotation 72, e.g., each connection distance of the device 100 may be substantially equal (plus or minus 5%, and more preferably plus or minus 1%) to the distance between the first axle 11 and the second axle 21.

In some embodiments, the first axle 11 and the second axle 21 may be coupled together via flexible coupling 51, and the flexible coupling 51 may rotationally engage the first axle 11 and the second axle 21 together so that rotation of one axle 11, 21, results in rotation of the other axle 11, 21. In preferred embodiments, the flexible coupling 51 rotationally couples the first axle 11 and the second axle 21 together so that rotation of the first axle 11 causes equal rotation of the second axle 21 and vice versa. A flexible coupling 51 is a mechanical device that connects two rotating shafts, allowing for the transmission of torque while accommodating minor misalignments (angular, parallel, or axial) and often dampening vibrations or absorbing shock. In preferred embodiments, a flexible coupling 51 may comprise a chain coupling which may utilize two or more sprockets connected by a double-strand roller chain or other suitable chain. In further embodiments, a flexible coupling 51 may comprise a belt coupling which may utilize two or more sprockets connected by a rubber belt or other suitable flexible belt. In further embodiments, a flexible coupling 51 may comprise a gear coupling which may utilize two or more external gear teeth on the hubs that engage with internal gear teeth on a sleeve or other geared arrangement. This meshing of gears allows for angular and axial misalignment through rocking and sliding motion of the teeth.

In preferred embodiments, the plurality of platforms 31, 32, 33, 34, may revolve around a flexible coupling 51 that is coupled to the first axle 11 and to the second axle 21. For example, the flexible coupling 51 may extend between the first axle 11 and to the second axle 21 and the plurality of platforms 31, 32, 33, 34, revolve may around the first axle 11 and to the second axle 21 and therefore revolve around the flexible coupling 51. In further embodiments, a flexible coupling 51 may be positioned above, below, in front, behind, or otherwise located outside of the revolving path of the plurality of platforms 31, 32, 33, 34.

In some embodiments, the first axis of rotation 71 of the first axle 11 and the second axis of rotation 72 of the second axle 21 may be substantially parallel (plus or minus 2.0 degrees of absolute parallel, and more preferably less than 1.0 degree of absolute parallel) to each other. In preferred embodiments, the first axis of rotation 71 of the first axle 11 and the second axis of rotation 72 of the second axle 21 may be substantially parallel and may be offset from each other e.g., the first axis of rotation 71 may be offset from the second axis of rotation 72 such that the first axis of rotation 71 does not extend through the second axis of rotation 72.

In some embodiments, the device 100 may comprise a stand 60 which may be a structure that is configured to support the axles, pluralities of elongated spokes, plurality of platforms 31, 32, 33, 34, and one or more other elements above a surface or object that the stand 60 is resting on or coupled to so that the plurality of platforms 31, 32, 33, 34, is able to revolve around the axles without contacting the surface or object. A stand 60 may be configured in any shape or size. For example, a stand 60 may comprise one or more lateral supports 61, 62, 63, 64, which may be generally horizontally oriented and which may rest on or be coupled to a surface or object that the stand 60 is resting on or coupled to. Optionally, a stand 60 may comprise one or more longitudinal supports 65, 66, 67, 68, that may extend vertically above the lateral supports 61, 62, 63, 64, and the axle rotational couplings 13, 23, may be coupled to the longitudinal supports 65, 66, 67, 68, so that the longitudinal supports 65, 66, 67, 68, and the axle rotational couplings 13, 23, may support the axles a desired distance above a surface or object that the stand 60 is resting on or coupled to. In preferred embodiments, the device 100 may comprise a stand 60 and the first axle rotational coupling 13 and the second axle rotational coupling 23 may be coupled to the stand 60 such that the first axle rotational coupling 13 may movably couple the first axle 11 to the stand 60 and the second axle rotational coupling 23 may movably couple the second axle 21 to the stand 60.

The device 100 may be configured to allow the platforms 31, 32, 33, 34, of the plurality of platforms 31, 32, 33, 34, to be rotated around a horizontal axis 73 extending parallel to and between the first axis of rotation 71 and the second axis of rotation 72 while the orientation of each platform 31, 32, 33, 34, of the plurality of platforms 31, 32, 33, 34, remains substantially constant. For example, each platform 31, 32, 33, 34, may comprise a platform upper surface 31A, 32A, 33A, 34A, and the orientation of each platform upper surface 31A, 32A, 33A, 34A, may remain substantially constant (e.g., plus or minus 2.0 degrees in an X-axis, Y-axis, and Z-axis extending through each platform 31, 32, 33, 34) as the plurality of platforms 31, 32, 33, 34, is rotated around the first axle 11 and second axle 21 (around a horizontal axis 73 extending parallel to and between the first axis of rotation 71 and the second axis of rotation 72).

In some embodiments, each platform 31, 32, 33, 34, of the plurality of platforms 31, 32, 33, 34, may comprise an orientation, and the orientation of each platform 31, 32, 33, 34, of the plurality of platforms 31, 32, 33, 34, may remain substantially constant (e.g., plus or minus 2.0 degrees in an X-axis, Y-axis, and Z-axis extending through each platform 31, 32, 33, 34) as one or more of the following conditions occur: the first plurality of elongated spokes 15, 16, 17, 18, and/or the second plurality of elongated spokes 25, 26, 27, 28, are rotated around a horizontal axis 73 extending parallel to and between the first axis of rotation 71 and the second axis of rotation 72; the first axle 11 and/or the second axle 21 is rotated around a horizontal axis 73 extending parallel to and between the first axis of rotation 71 and the second axis of rotation 72; and one or more of the platforms 31, 32, 33, 34, of the plurality of platforms 31, 32, 33, 34, are rotated around a horizontal axis 73 extending parallel to and between the first axis of rotation 71 and the second axis of rotation 72.

In preferred embodiments, the orientation of each platform 31, 32, 33, 34, of the plurality of platforms 31, 32, 33, 34, may remain substantially constant (e.g., plus or minus 2.0 degrees in an X-axis, Y-axis, and Z-axis extending through each platform 31, 32, 33, 34) during one or more of the following above listed conditions may occur due to one or more of the following: the first axle 11 and the second axle 21 being coupled together via flexible coupling 51; each elongated spoke 15, 16, 17, 18, of the first plurality of elongated spokes 15, 16, 17, 18, being substantially equal in length; each elongated spoke 25, 26, 27, 28, of the second plurality of elongated spokes 25, 26, 27, 28, being substantially equal in length; each elongated spoke 15, 16, 17, 18, of the first plurality of elongated spokes 15, 16, 17, 18, is substantially equal in length to each elongated spoke 25, 26, 27, 28, of the second plurality of elongated spokes 25, 26, 27, 28,; the connection distance of each platform 31, 32, 33, 34, being substantially equal; the first axis of rotation 71 of the first axle 11 being substantially parallel to the second axis of rotation 72 of the second axle 21; and the first axis of rotation 71 being offset a certain distance from the second axis of rotation 72 in which the certain distance is substantially equal (plus or minus 1.0%) to the connection distance of each platform 31, 32, 33, 34.

While some exemplary shapes and sizes have been provided for elements of the device 100, it should be understood to one of ordinary skill in the art that the axles 11, 21, elongated spokes 15, 16, 17, 18, 25, 26, 27, 28, platforms 31, 32, 33, 34, stand 60, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An offset flywheel device, the device comprising:
a first axle coupled to a first axle rotational coupling, the first axle having a first axle hub;
a first plurality of elongated spokes coupled to the first axle hub, wherein each elongated spoke of the first plurality of elongated spokes radiates from the first axle hub;
a second axle coupled to a second axle rotational coupling, the second axle having a second axle hub;
a second plurality of elongated spokes coupled to the second axle hub, wherein each elongated spoke of the second plurality of elongated spokes radiates from the second axle hub; and
a plurality of platforms, wherein each platform of the plurality of platforms is movably coupled to one elongated spoke of the first plurality of elongated spokes and to one elongated spoke of the second plurality of elongated spokes, and wherein the plurality of platforms rotationally couples the first plurality of elongated spokes to the second plurality of elongated spokes so that rotation of the first plurality of elongated spokes causes equal rotation of the second plurality of elongated spokes.

2. The device of claim 1, wherein the first axle and the second axle are coupled together via flexible coupling.

3. The device of claim 2, wherein the flexible coupling is a chain coupling.

4. The device of claim 2, wherein the plurality of platforms revolve around the flexible coupling.

5. The device of claim 1, wherein the first axle comprises a first axis of rotation, wherein the second axle comprises a second axis of rotation, and wherein the first axis of rotation is substantially parallel to the second axis of rotation.

6. The device of claim 5, wherein the first axis of rotation is offset from the second axis of rotation.

7. The device of claim 1, wherein each platform of the plurality of platforms comprises a connection distance, and wherein each connection distance is substantially equal.

8. The device of claim 1, wherein each elongated spoke of the first plurality of elongated spokes is substantially equal in length.

9. The device of claim 1, wherein each elongated spoke of the second plurality of elongated spokes is substantially equal in length.

10. The device of claim 1, wherein each elongated spoke of the first plurality of elongated spokes is substantially equal in length to each elongated spoke of the second plurality of elongated spokes.

11. The device of claim 1, further comprising a stand, wherein the first axle rotational coupling is coupled to the stand, and wherein the second axle rotational coupling is coupled to the stand.

12. An offset flywheel device, the device comprising:
a first axle coupled to a first axle rotational coupling, the first axle having a first axle hub;
a first plurality of elongated spokes coupled to the first axle hub, wherein each elongated spoke of the first plurality of elongated spokes radiates from the first axle hub
a second axle coupled to a second axle rotational coupling, the second axle having a second axle hub, wherein the first axle and the second axle are coupled together via flexible coupling;
a second plurality of elongated spokes coupled to the second axle hub, wherein each elongated spoke of the second plurality of elongated spokes radiates from the second axle hub; and
a plurality of platforms, wherein each platform of the plurality of platforms is movably coupled to one elongated spoke of the first plurality of elongated spokes and to one elongated spoke of the second plurality of elongated spokes, wherein the plurality of platforms rotationally couples the first plurality of elongated spokes to the second plurality of elongated spokes so that rotation of the first plurality of elongated spokes causes equal rotation of the second plurality of elongated spokes, wherein each platform of the plurality of platforms comprises a connection distance, and wherein each connection distance is substantially equal, wherein each platform of the plurality of platforms comprises an orientation, and wherein the orientation of each platform of the plurality of platforms remains substantially constant as the first plurality of elongated spokes and the second plurality of elongated spokes are rotated around a horizontal axis extending parallel to and between the first axis of rotation and the second axis of rotation.

13. The device of claim 12, wherein the flexible coupling is a chain coupling.

14. The device of claim 12, wherein the plurality of platforms revolve around the flexible coupling.

15. The device of claim 12, wherein the first axle comprises a first axis of rotation, wherein the second axle comprises a second axis of rotation, and wherein the first axis of rotation is substantially parallel to the second axis of rotation.

16. The device of claim 15, wherein the first axis of rotation is offset from the second axis of rotation.

17. The device of claim 12, wherein each elongated spoke of the first plurality of elongated spokes is substantially equal in length.

18. The device of claim 12, wherein each elongated spoke of the second plurality of elongated spokes is substantially equal in length.

19. The device of claim 12, wherein each elongated spoke of the first plurality of elongated spokes is substantially equal in length to each elongated spoke of the second plurality of elongated spokes.

20. The device of claim 12, further comprising a stand, wherein the first axle rotational coupling is coupled to the stand, and wherein the second axle rotational coupling is coupled to the stand.
